(19) United States
(12) Patent Application Publication
(10) Pub. No.: US 2011/0060502 A1
(43) Pub. Date: Mar. 10, 2011

(54) MOTOR VEHICLE WITH A RIDE LEVEL CONTROL DEVICE

(75) Inventors: Markus Atz, Weingarten (DE); Thomas Hieber, Boertlingen (DE); Achim Schulz, Niefern-Oeschelbronn (DE); Frank Poppe, Kirchheim-Teck (DE)

(73) Assignee: DR. ING. H.C. F. PORSCHE AKTIENGESELLSCHAFT, Stuttgart (DE)

(21) Appl. No.: 12/879,168

(22) Filed: Sep. 10, 2010

(30) Foreign Application Priority Data
Sep. 10, 2009 (DE) 10 2009 042 165.3

(51) Int. Cl. B60G 17/016; B60Q 1/06

(52) U.S. Cl. 701/37

(57) ABSTRACT

A motor vehicle is proposed having a ride level control device with a pneumatic lift system , with a ride level control unit, to which the operating parameters of the motor vehicle which are detected by sensors are fed. The ride level control unit is active if the ignition of the motor vehicle is switched on. Furthermore, when various conditions are met, the ride level control unit outputs a signal to the lift system so that the motor vehicle is raised. A bidirectional connection is present between the ride level control unit and the lift system in order to transmit feedback from the lift system to the ride level control unit.

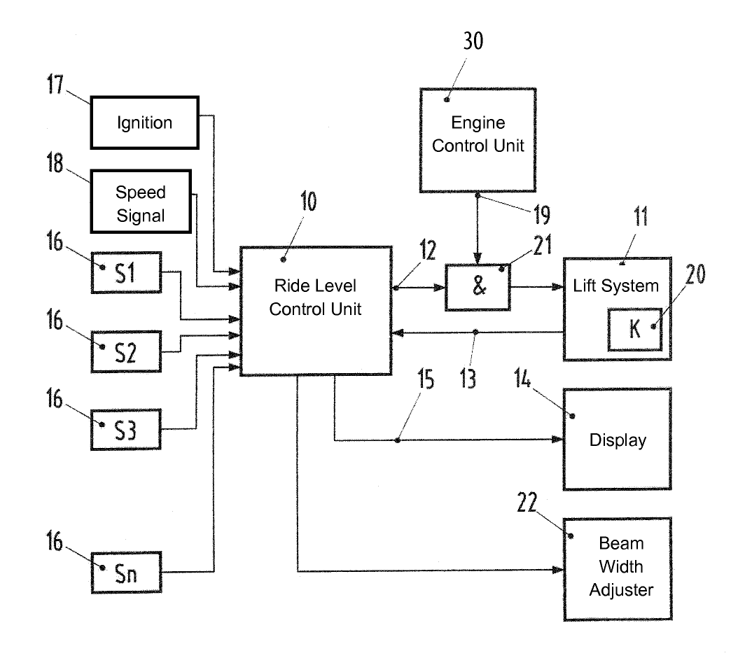

### CROSS-REFERENCE TO RELATED APPLICATION

This application claims the priority, under 35 U.S.C. §119, of German application DE 10 2009 042 165.3, filed Sep. 10, 2009; the prior application is herewith incorporated by reference in its entirety.

### BACKGROUND OF THE INVENTION

### Field of the Invention

The invention is based on a motor vehicle with a ride level control device, wherein the bodywork of the vehicle can be placed at a raised level with respect to the roadway in order to avoid damage when the ground is uneven, and can be placed at a lowered level.

Such an arrangement is known, for example, from German patent DE 100 53 316 B4. In this known arrangement, a vehicle bodywork is provided with a front apron and with a ride level adjustment device which causes the car body to be lifted up in order, for example to protect the front apron against damage in the event of raised areas of the ground. For this purpose, in this known prior art an obstacle sensor device is arranged in the front region of the motor vehicle, and when the motor vehicle approaches an obstacle the obstacle sensor device outputs a corresponding obstacle sensor signal which is passed onto the ride level control device. The ride level control device actuates a ride level adjuster and the vehicle bodywork is raised automatically to a relatively high ride level compared to a currently set ride level. In this context it is also known to activate the ride level control device manually and/or in an automated fashion as a function of driving parameters by a control algorithm.

### SUMMARY OF THE INVENTION

It is accordingly an object of the invention to provide a motor vehicle with a ride level control device which overcomes the above-mentioned disadvantages of the prior art devices of this general type, which improves the actuation in order to change or adapt the ride level of the motor vehicle.

With the foregoing and other objects in view there is provided, in accordance with the invention a motor vehicle. The motor vehicle contains an ignition, sensors, and a ride level control device having a pneumatic lift system and a ride level control unit to which operating parameters of the motor vehicle detected by the sensors are fed. The ride level control unit being active if the ignition of the motor vehicle is switched on. When various conditions are met, the ride level control unit outputs a signal to the lift system and lifting of the motor vehicle takes place. A bidirectional connection between the ride level control unit and the lift system is present and feedback from the lift system to the ride level control unit takes place.

For example, a plurality of information items relating to the current operating conditions for evaluation and adaptation of the actuation are fed to the inventive system for actuating the ride level of a vehicle. In this context, the various sensor signals which are already available to the vehicle can advantageously be passed on via a bus system to a ride level control unit and evaluated there in accordance with predefined algorithms. The ride level control unit correspondingly actuates a pneumatic lift system which causes the vehicle to be raised and lowered.

A further advantage is the provision of various locking conditions in which the actuation of the lift system of the vehicle is prohibited or interrupted. It has proven particularly advantageous that the actuation of a lift system is permitted only if the motor of the vehicle is running and a predefinable speed is not exceeded. The pneumatic system is also configured in such a way that the last position of the ride level actuation after the machine has been switched off remains even without active actuation. The system can thus store the last position and use this position for the basis for further actuations when a restart occurs.

A further advantage results from the fact that after relatively long stationary times when a pressure loss has led to lowering of the vehicle, a check is carried out after the engine starts in order to determine whether the vehicle is in an intermediate position. In this case, if there is sufficient pressure in the pneumatic system the vehicle is raised automatically.

A further advantage results from the monitoring of the system to determine whether, after the starting of the system, the setpoint pressure is built up in the system within a predefinable maximum actuation time. If this is not the case, no further actuation occurs and a fault in the system is completed and a warning message is output. In this case, it is advantageously possible to switch over to an emergency running function.

A further advantage emerges from the coupling of the system to an automatic beam width adjustment. It is therefore possible to ensure that the oncoming traffic is not dazzled after the raising of the vehicle on the front axle.

Other features which are considered as characteristic for the invention are set forth in the appended claims.

Although the invention is illustrated and described herein as embodied in a motor vehicle with a ride level control device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single figure of the drawing is a block diagram of a basic configuration of an arrangement for controlling a ride level in a motor vehicle according to the invention.

### DETAILED DESCRIPTION OF THE INVENTION

Referring now to the figure of the drawing in detail, there is shown a basic configuration of an arrangement for adjusting a ride level of a vehicle. A central unit is the ride level control unit which is donated by the reference symbol 10.

The ride level control unit 10 actuates the valves (not illustrated in the drawing) and a compressor 20 of a pneumatic lift system 11. In this context, signals 12 of the ride level control unit 10 are passed on together with signals 19 of an engine control unit 30 in an AND logic element 21 to the lift system 11. The lift system 11 is in turn connected via a feedback line 13 to the ride level control unit 10 and provides the ride level control unit 10 with feedback as to whether the final position for the raised state or the lowered state is reached after a corresponding control signal. At the same time, the driver is provided with information via a display 14 which is connected to the ride level control unit 10 via a connection 15. The display 14 may be here an LED or corresponding lettering in the combination instrument.

The ride level control unit 10 receives a plurality of signals S1 to Sn, which are represented by the reference sign 16 in the figure. These signals S1 to Sn may be, for example, a system temperature, a position of the motor vehicle doors, positions of further adjustment elements such as a soft top, a rear spoiler and/or front spoiler.

Furthermore, the signal of an ignition 17 and a speed signal 18 are fed to the ride level control unit 10. The signal from the ignition 17 and speed signal 18 are also evaluated in the engine control unit 30, and a signal 19 is output by the engine control unit 20 only when the ignition of the engine is switched on and the speed is below a predefinable value. This ensures that the signal 12 which is output by the ride level control device 10 is output to the lift system 11 for actuation only when both conditions (engine running, speed below the reference value) are met.

All the necessary and available signals are therefore detected and processed in accordance with the predefined conditions.

A further signal, which is fed to the ride level control unit 10 from the lift system 12 via the connection 13, is information about the pressure in the lift system 11. The system pressure is detected by a non-illustrated pressure switch and the lift function is deactivated below a predefinable first pressure value. In return, the system is not enabled again until the system pressure reaches a predefinable second pressure value, wherein the second pressure value is higher than the first pressure value, as a result of which a hysteresis is implemented. In order to adapt the system pressure, a compressor 20 is provided in the lift system 11. The compressor 20 is switched on when the system pressure drops below the first pressure value, and is switched off when the second predefinable pressure value is reached.

A thermal protector is defined in the ride level control unit 10 so that the temperature is evaluated for the actuation of the thermal protector.

After the ignition has been switched off, the last position of the lift system 11 is maintained. Therefore if the motor was raised, it is still in the raised position when restarting occurs.

If the motor vehicle is in an intermediate position after the starting of the engine, the vehicle is raised provided there is sufficient pressure in the pneumatic lift system 11. In this case, the ride level control unit 10 automatically activates the raising process.

However, if there is no system pressure present after the starting process, the motor vehicle remains in the instantaneous intermediate position. In the further course, the system pressure is monitored after the engine starts to determine whether it reaches the setpoint pressure within a predefinable time. If this is the case, the raising function is automatically carried out. If no sufficient system pressure was able to be built up within the predefinable time, the intermediate position is maintained. If the vehicle is in a lowered position after the starting of the engine, no activation by the ride level control unit 10 takes place.

For actuation in the driving mode of the vehicle, the speed v is monitored and as soon as a speed limit v (limit) is exceeded, the vehicle is moved into a lowered position.

The lift system 11 provided according to the invention is a pneumatic system which contains the compressor 20. As has already been specified above, information about the lift system 11 indicating whether sufficient pressure is present in the lift system 11 is also made available to the ride level control unit 10. If this is not the case, the compressor 20 is actuated. Further conditions have to be met for the actuation of the compressor. For example, the engine must be running, the signal of the pressure switch indicates a value which is lower than a lower limiting value, the vehicle must not be in an active lowered position, and the thermal protection is not activated. After an upper limiting value has been reached, the compressor 20 is switched off again.

When a defined thermal protection responds, the raising of the vehicle is aborted after a predefinable waiting time of, for example, 10 seconds, if the selected raised position has not been reached.

Furthermore, a predefinable limiting speed is defined and when this predefinable limiting speed is exceeded when the vehicle is not in the lowered position, then one warning message is output to the driver via the combination instrument.

With the present system it is also possible to carry out leak detection. If, for example, the setpoint pressure is not reached within a maximum actuation time of the compressor in a pneumatic system, no renewed actuation of the compressor 20 is carried out during this driving cycle and it is concluded that a leak is present. A warning message is issued in the system.

A fault in the system is also presumed if both end positions are detected as being activated at the same time if relevant information is not available via the bus system or if the system pressure is not reached after a maximum actuation time of the compressor. In order to avoid inadvertent warning messages, the pressure switch for the lower end position is debounced to the time of, for example, two seconds. Pressure peaks, which occur as a result of movements of the vehicle body in the driving mode, can therefore also be equalized.

If such a system failure occurs, the lift function is not available during the current driving cycle and an emergency running function is generated.

In addition to the automatic actuation of the lift system, manual control may also be provided, and may be carried out, for example, by a push button key which can be operated by the driver. The push button key is operated, for example, in jog mode. This means that the vehicle is raised or lowered automatically until the respective end position is reached after the push button key has been depressed once. In order to avoid unnecessary upward and downward movements of the vehicle, a protection function is integrated. This provides for the manual raising to be limited to a defined number, for example to six actuations within a predefinable time period. If this number is exceeded, a corresponding protection function is triggered and the manual actuation of the ride level control unit remains locked for a predefinable time. This may be signaled to the driver in the combination instrument.

Finally, it is also to be noted that the raising and lowering of the vehicle influences the beam width of the headlights. In order to avoid dazzling of the oncoming traffic, a beam width adjuster LWR is indicated by the reference symbol 22 in the figure. The beam width adjuster LWR is coupled, inter alia, to the ride level control unit and ensures that the headlights are correspondingly lowered when the vehicle is raised.

1. A motor vehicle, comprising:
an ignition;
sensors; and
a ride level control device having a pneumatic lift system and a ride level control unit to which operating parameters of the motor vehicle detected by said sensors are fed, said ride level control unit being active if said ignition of the motor vehicle is switched on, wherein when various conditions are met, said ride level control unit outputs a signal to said lift system and lifting of the motor vehicle takes place, wherein a bidirectional connection between said ride level control unit and said lift system is present and feedback from said lift system to said ride level control unit takes place.

2. The motor vehicle according to claim 1, wherein a pressure in said pneumatic lift system is measured, and in that the lifting up of the motor vehicle is prevented if the pressure in said pneumatic lift system is not sufficient or if a speed of the motor vehicle exceeds a predefinable limiting value.

3. The motor vehicle according to claim 2, wherein the predefinable speed is 60 km/h.

4. The motor vehicle according to claim 2, further comprising a compressor, when the pressure in said lift system drops below a lower predefinable value, said compressor is activated, and is switched off again when an upper predefinable pressure is reached.

5. The motor vehicle according to claim 4, wherein when said compressor is activated after a defined time, the pressure is checked again, and a fault message is issued when the pressure is not reached.

6. The motor vehicle according to claim 1, further comprising:
a headlight; and
a beam width adjuster connected to ride level control unit, said beam width adjuster causes said headlight to be lowered when the motor vehicle is raised.
